(19) United States
(12) Patent Application Publication
(10) Pub. No.: US 2013/0063735 A1
(43) Pub. Date: Mar. 14, 2013

(54) SELECTIVE PRINT

(71) Applicants: Rajaraman Hariharan, Bangalore (IN); Subramaniam Meenakshisundaram, Bangalore (IN); Monica O. Joshi, Bangalore (IN); Ramakrishnan Kannan, Yorktown Heights, NY (US)

(72) Inventors: Rajaraman Hariharan, Bangalore (IN); Subramaniam Meenakshisundaram, Bangalore (IN); Monica O. Joshi, Bangalore (IN); Ramakrishnan Kannan, Yorktown Heights, NY (US)

(73) Assignee: INTERNATIONAL BUSINESS MACHINES CORPORATION, Armonk, NY (US)

(21) Appl. No.: 13/230,474

(22) Filed: Sep. 12, 2011

(51) Int. Cl. G06K 15/02

(52) U.S. Cl. 358/1.6

(57) ABSTRACT

A method and system for printing selective contents of a document is provided. The method includes selecting a plurality of sections in the document based on a plurality of inputs received to select the plurality of sections. The method then arranges the contents associated with the plurality of selected sections in a template. Further the method prints the template including contents associated with the plurality of selected selections of the document in a single printing job in a predefined number of pages. The method also associates the plurality of selected sections with plurality of divisions of a template.

### FIELD OF THE INVENTION

Embodiments of the present invention relates to printing of selective contents of a document.

### BACKGROUND OF THE INVENTION

Today, printing applications in computing devices provide customizable print options to users. The customizable print option includes, but is not limited to, printing specific pages or specific sections of a document. Hence, the user can print selected pages of the document and can omit printing of the remaining pages of the document. The printing applications also provide an option of selecting specific section of the document and thereby printing only the selected section. However, when a large data model (or architecture diagram) needs to be printed on a standard size paper or a predefined size paper, for example an A4 size paper, then the application cuts the content as per a print area size or may print the contents on multiple pages. Hence, the user have to copy different contents from one document and paste them in another document, if the user insists on getting only relevant content of the document printed.

As a result, it becomes very difficult to print large diagrams (data models) on a common A4 size paper, or a similar size paper. In a scenario, the printer applications generally separate the content based on printable area if the contents of the document is large and exceeds the maximum printable size. However, as the printer application tends to separate the contents, the logical meaning is not preserved because the pages are not separated in a logical way. In another scenario, the printer application can also shrink the contents of the diagram to the printable area. Hence, in such scenario, the content may become small and unreadable for the user.

Similarly, content trimming options are also available in the applications for adjusting and arranging the contents of the documents. However, the content trimming option only removes blank lines. Thus, the content trimming options is useful when minor overflows are to be accommodated by shrinking the overall content or by removing blank lines. Presently, for selective printing the contents are manually arranged by the user by copying, pasting and editing the contents of the document on other documents. The manual process is inefficient and time consuming.

### BRIEF SUMMARY OF THE INVENTION

According to one embodiment of the present invention, a method of printing selective contents of a document is provided. The method includes selecting a plurality of sections in the document based on a plurality of inputs received to select the plurality of sections. The method then arranges the contents associated with the plurality of selected sections in a template. Further, the method prints the template including the contents associated with the plurality of selected selections in a single printing job.

According to another embodiment of the present invention, a computer system for printing selective contents of a document is provided. The system includes one or more processors. The processor includes program instructions to select a plurality of sections in the document based on a plurality of inputs received to select the plurality of sections. The processor then arranges the contents associated with the plurality of selected sections in a template. Further, the processor is adapted to print the template including the contents associated with the plurality of selected selections in a single printing job.

According to yet another embodiment of the present invention, a computer program product for printing selective contents of a document is provided. The computer program product comprises one or more computer-readable tangible storage devices and program instructions stored on at least one or more storage devices, the program instructions comprising program instruction to select a plurality of sections in the document based on a plurality of inputs received to select the plurality of sections, a program instruction to arrange the contents associated with the plurality of selected sections in a template and a program instruction to print the template including the contents associated with the plurality of selected selections in a single printing job.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE DRAWINGS

FIG. 1 illustrates an exemplary environment where multiple sections of a document are selected, in accordance with an embodiment of the invention;

FIG. 2 illustrates an exemplary method of arranging contents associated with the multiple sections in multiple divisions of a template, in accordance with an embodiment of the invention;

FIG. 3 illustrates an exemplary block diagram representing components and modules for implementing a method to print contents associated with the multiple section, in accordance with an embodiment of the invention;

FIG. 4 illustrates a flowchart diagram representing a method of printing selective contents of a document, in accordance with an embodiment of the invention; and

FIG. 5A, FIG. 5B and FIG. 5C illustrates a flowchart diagram representing a method of printing selective contents of a document, in accordance with another embodiment of the invention.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the various embodiments of the invention can be practiced without one or more of the specific details, or with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

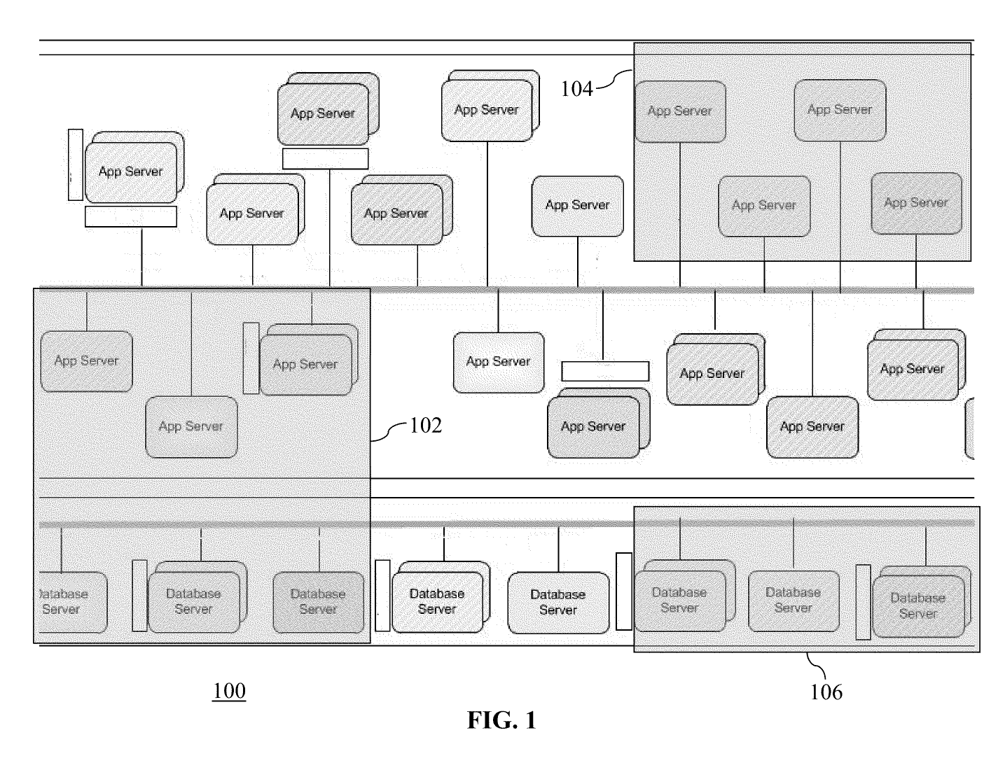

FIG. 1 through 5, as discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Further, terms such as “first”, “second”, etc., are used to differentiate between objects having the same terminology and are nowhere intended to represent a chronological order, except where stated otherwise. A set is defined as a non-empty set including at least one element.

FIG. 1 illustrates an exemplary environment where multiple sections of a document are selected, in accordance with an embodiment of the invention.

Referring to FIG. 1, an environment 100 is shown to include a block diagram representing a plurality of servers connected with each other. In the environment 100, different sections of the block diagram can be selected and thereafter the selected sections can be printed as a single content in a predefined number of pages. For the sake of clarity and the purpose of this description, the environment 100 is shown to include three selected sections, a section 102, a section 104, and a section 106. However, a user can select more or less number of sections of the block diagram based on the requirements.

In an embodiment, the multiple selection option is provided to the user prior to printing the document. Thus, if the user selects the multiple selection option, then the user is allowed to select one or more different sections of the document. The contents of the selected sections, for example the section 102, 104 and 106 are combined to form a single document and thereafter the selections are sent for printing. In the environment 100, the contents of the section 102, the section 104 and the section 106 are selected and the contents are collectively sent for printing in a single printing job while eliminating the non-selected portions of the block diagram.

In an embodiment, the contents of the selected sections are printed in a predefined number of pages. In an embodiment, the predefined number of pages is set as default for every printing job. In another embodiment, the predefined number of pages is provided by the user in run time prior to printing the job. In an embodiment, the contents associated with the selected sections are automatically adjusted in the predefined number of pages.

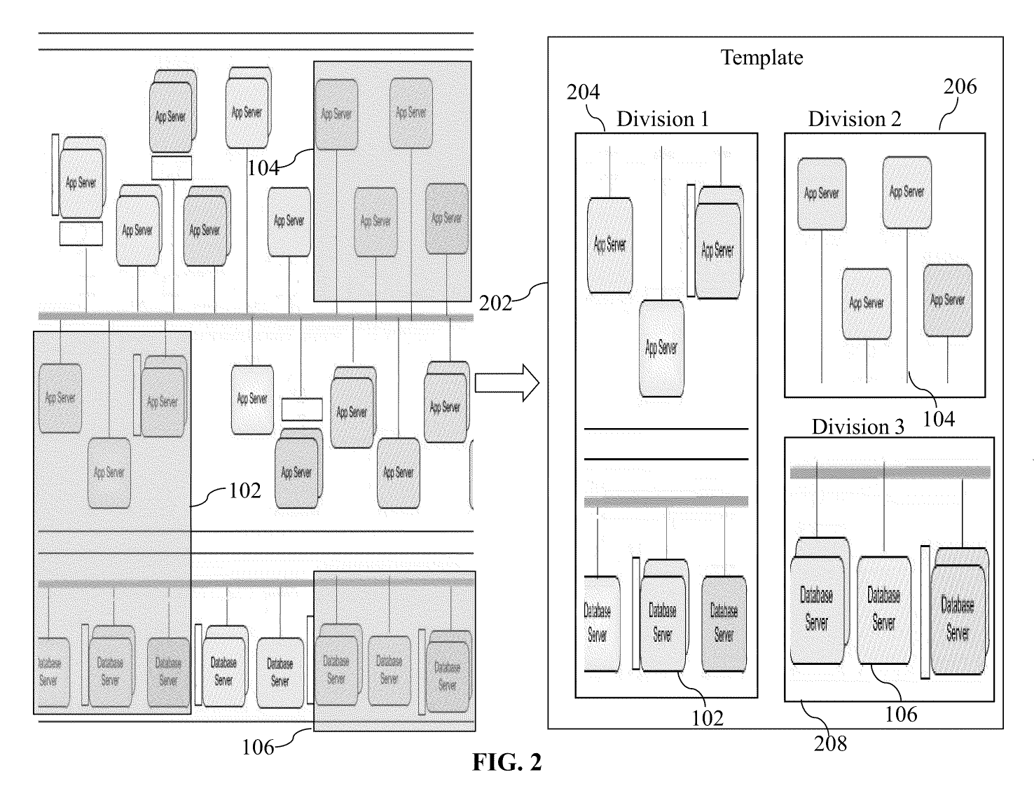

In an embodiment, the contents associated with the selected sections are arranged in a template. In an embodiment, the template is a predefined template that is stored in a memory of a system. In another embodiment, the template is created by a user in run time. The arranging of contents associated with the selected sections in the template is explained in conjunction with FIG. 2.

Referring to FIG. 2, a template 202 includes three divisions, a division 204, a division 206 and a division 208. In an embodiment, the template 202 is a predefined template. In another embodiment, the template 202 is defined by the user at run time. The three divisions of the template 202 can be associated with the selections made by the user in a document. For example, the selections made by the user in FIG. 1 can be arranged in the three divisions of the template 202. Hence, the contents associated with the selected sections 102, 104 and 108 are arranged in the divisions 204, 206 and 208 respectively. In an embodiment, the contents of the selected sections are arranged in the divisions based on the manual inputs received from the user. In the embodiment, the user is given a choice for associating the selected section with any one of the division of the template 202.

In another embodiment, the contents of the selected sections are automatically arranged in the divisions of the template 202 based on a predefined criteria. An example of predefined criteria includes associating the selection number with the division number of the template. For example, the first selection 102 is associated with the first division 204 of the template and likewise the selection 104 with the second division 206 and the selection 106 with the third division 208. Hence, a block diagram depicted in the selection 102 is arranged in the division 204, a block diagram depicted in the selection 104 is arranged in the division 206 and a block diagram depicted in the selection 106 is arranged in the division 208. In an embodiment, the area of the divisions is adjusted automatically to accommodate the contents of the selected sections associated with the division.

In an embodiment, the template 202 with the contents of the selected sections 102, 104 and 106 can also be previewed (pint preview) before printing and the user can modify the size of the selected selection. For example, the user can zoom-in or zoom-out any division to enlarge or reduce the size of the contents associated with the division. In an embodiment, the zoom level of a section can be automatically determined based on size of the selection and the size of the corresponding division in the template.

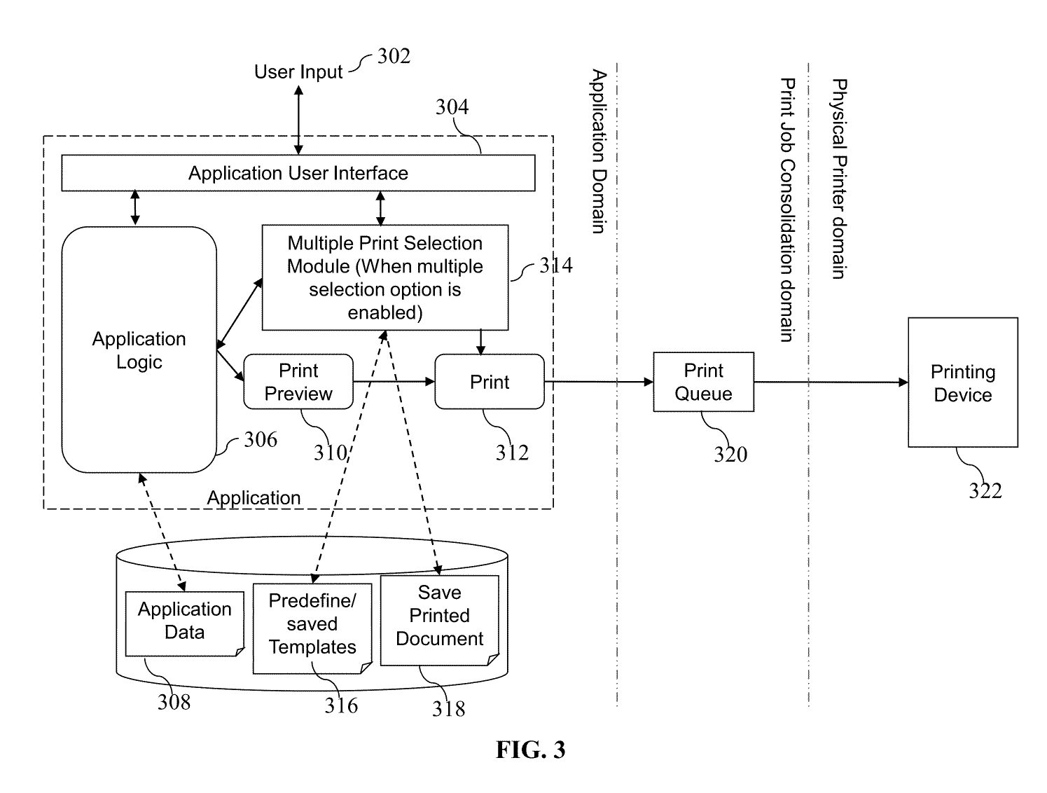

Referring to FIG. 3, a user input for printing a job is received at 302 in a computer system (processor). The printing job is then analyzed by the application user interface 304 based on the application logic 306 and the application data 308. In an embodiment, the user is not allowed to select multiple sections in the document, if the user does not enable multiple selection option for the document. Hence in the embodiment, a single selection request or a request with no selection is received from the user at 302. The user can then preview the document based on the selection request received using a print preview module 310. The document can thereafter be sent for printing by a printing module 312.

In an embodiment, the user is allowed to select multiple sections of the document if the user enables multiple selection option. The multiple selections are performed using the multiple print selection module 314 and the application logic 306. In an embodiment, the multiple selected sections can be captured in a saved template 316. In an embodiment, a template can be created by the user in run time and the created template can then be saved in a memory. The saved template can be re-used by the user for printing another job. In an embodiment, the document selected for printing can also be saved in the memory, for example in a save printed document module 318.

The selected sections can then be previewed by the user using the print preview module 316, and thereafter the document with the multiple selected sections can be sent for printing using print module 312. The print job is then pooled in the print queue 320 and thereafter the print job is sent to a printing device 322 for printing based on the predefined printing method/algorithm.

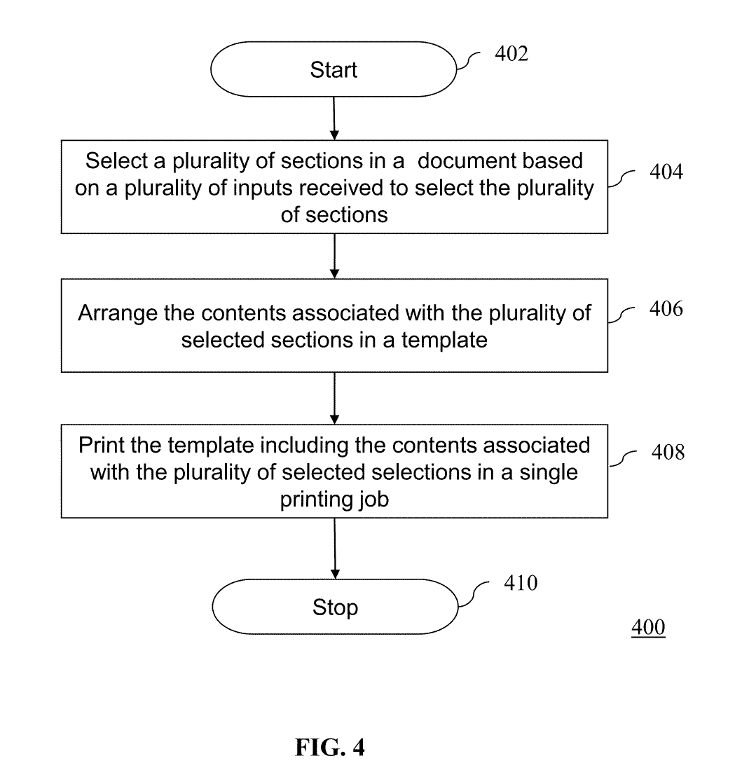

Referring to FIG. 4, the method 400 is initiated at step 402. At step 404, the method selects a plurality of sections in a document based on a plurality of inputs received by a user to select the plurality of sections. In an embodiment, multiple selection option is enabled in the document prior to selecting the plurality of sections.

The plurality of the selected sections are arranged to form a single document. The plurality of selected sections can then be previewed by the user. The method 400 also allows the user to modify the size of sections from the selected sections. For example, size of one of the sections can be increased by zooming in the contents and similarly contents of one of the sections can be reduced.

At step 406, contents of the selected sections can be arranged in a template, for example the template 202. The contents of the selected sections are then automatically arranged in different divisions of the template based on the predefined criteria. At step 408, the method 400 prints the template including the contents associated with the plurality of selected selections of the document in a single printing job. At step 410, the method 400 is terminated.

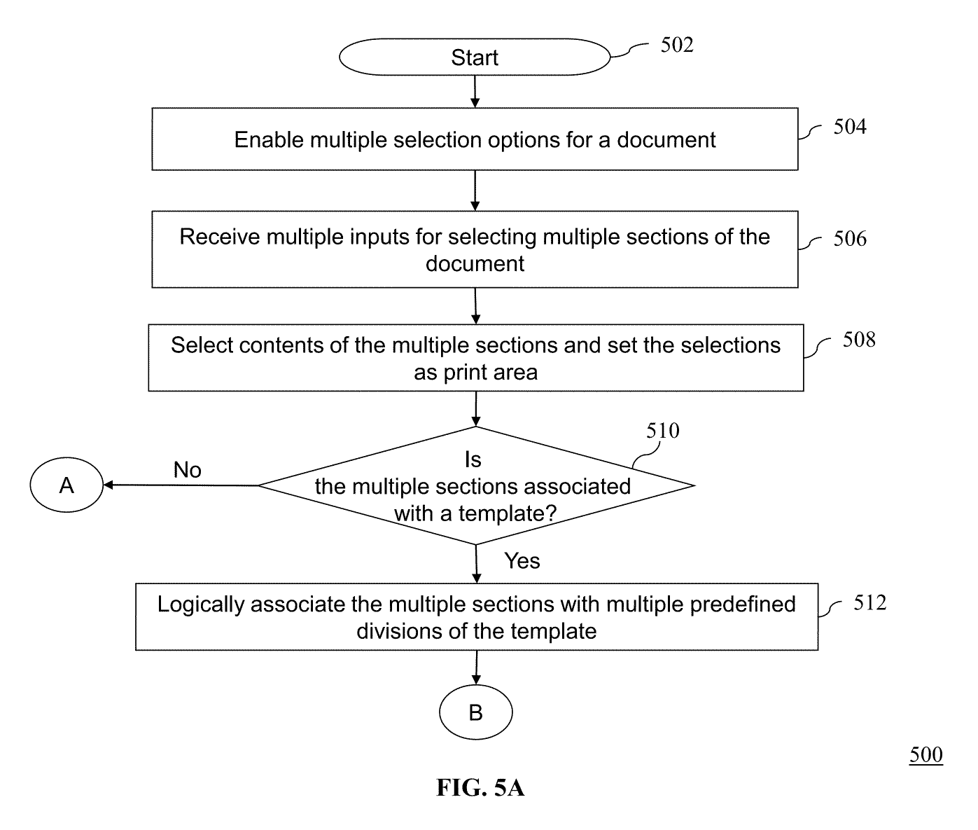

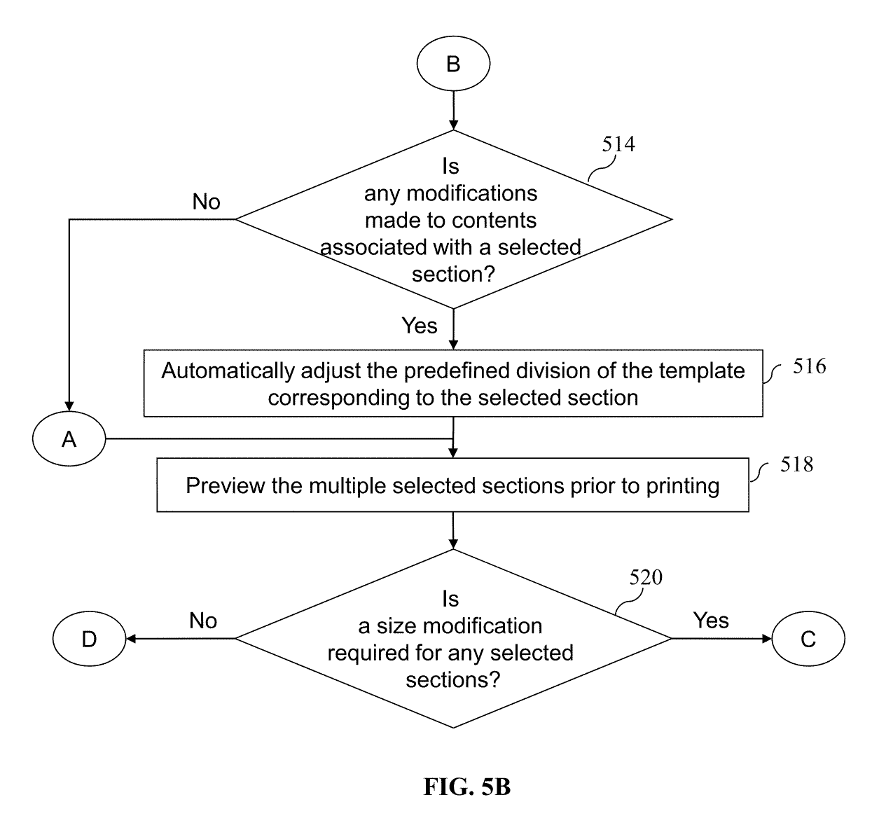

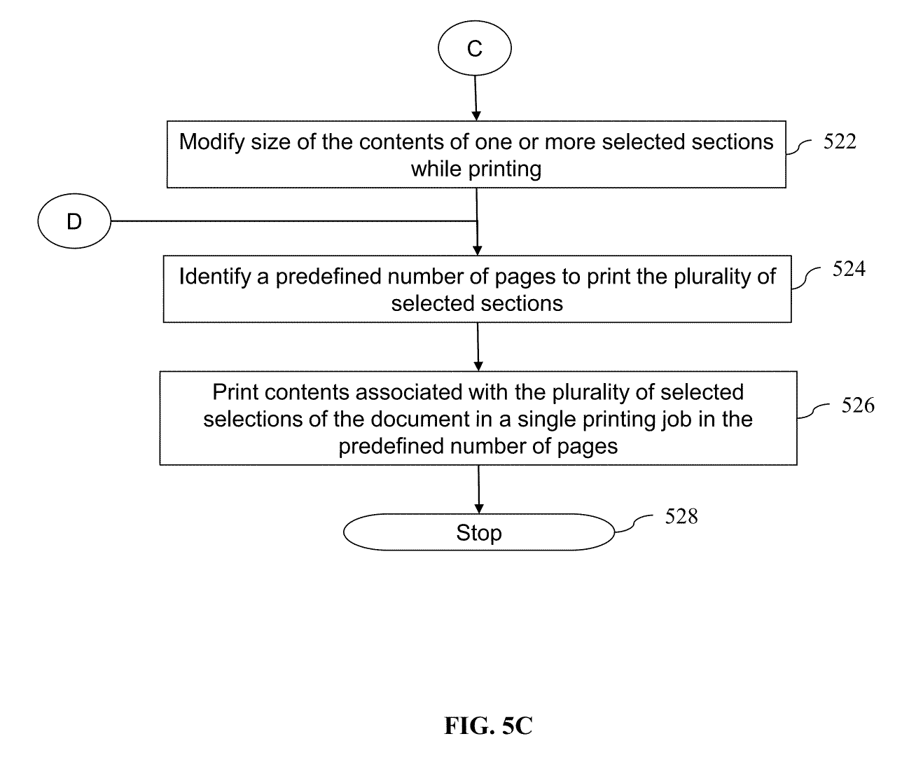

Referring to FIG. 5A, the method 500 is initiated at step 502. At step 504, multiple selection option is enabled. The multiple selection options enable a user to sequentially select multiple sections from different locations of the document. At step 506, multiple inputs are received from the user for selecting multiple sections of the document. At step 508, the method selects contents of the selected multiple sections and set the selections as print area. For example in the environment 100, the sections 102, the section 104 and the section 106 is selected in the document.

At step 510, the method 500 checks whether the multiple selections is associated with a template. Hence, if the multiple sections is associated with the template then a step 512 is performed otherwise a step 518 is performed. At step 512, the method logically associates the multiple selected sections with multiple predefined divisions of the template. For example, the sections 102, 104, and 106 are associated with the divisions 204, 206 and 208 respectively.

Referring to FIG. 5B, at step 514, the method checks if any modification is made to any contents associated with a selected section. For example, the method checks whether any modifications is made to any contents of the sections 102, 104 and 106. Hence, if any modifications are identified at step 514 then step 516 is performed otherwise the step 518 is performed. At step 514, the method automatically adjusts the modified contents in the predefined division of the template. For example, if any modifications are made in the contents of the section 104 then the corresponding division 206 (division 2) of the template 202 is automatically adjusted to accommodate the modified contents of the section 106.

At step 518, the user can preview the multiple selected sections of the document. At step 520, the method checks if a size modification is required for any selected sections. For example, after previewing the template 202, the method checks if any input is received by the user to modify any of the divisions, for example the division 204, 206, and 208.

Referring to FIG. 5C, at step 522, size of the contents of one or more selected sections is modified while printing the selected sections of the documents. In the example, the user can increase the size of the contents associated with one section and can reduce the size of the contents of another sections without actually changing the original contents. Hence, the user can zoom in the contents of the section 104 and can similarly reduce the size of the other section while printing.

At step 524, a predefined number of pages are identified to print the plurality of selected sections. In an embodiment, the number of pages is defined by the user. In another embodiment, the number of pages is automatically identified by the method based on the contents of the selected sections. At step 526, the method prints the contents associated with the plurality of selected selections of the document in a single printing job in the predefined number of pages. For example, the template 202 with the selected sections 102, 104 and 106 can be printed using a single printing job in a single page. At step 528, the method 500 is terminated.

Various embodiments of the present invention described above may provide at least, but are not limited to, the following advantages. The present invention provides a method of printing selective contents of a document. The method allows the user to select plurality of sections in a document and the plurality of sections can then be printed using a single printing job.

The method also captures and arranges the contents of the plurality of selected sections in different divisions of a template. This allows the user to print the selected sections in predefined format. The template can also be created at run time while printing. The template can also be stored in a memory so that the template can be reused for other printing jobs. Further, the method allows the user to modify the size of contents of different sections independently. The contents of the selected sections are also adjusted automatically in different divisions of the template.

As will be appreciated by one skilled in the art, aspects of the present invention may be embodied as a system, method or computer program product. Accordingly, aspects may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for various aspects may be written in any combination of one or more programming languages, including an object oriented programming language such as Java™, Smalltalk, C++ or the like and conventional procedural programming languages, such as the “C” programming language or similar programming languages. The program code may execute entirely on a single computer (device), partly on a single computer, as a stand-alone software package, partly on single computer and partly on a remote computer or entirely on a remote computer or server. In the latter scenario, the remote computer may be connected to another computer through any type of network, including a local area network (LAN) or a wide area network (WAN), or the connection may be made for example through the Internet using an Internet Service Provider.

Aspects are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A method for printing selective contents of a document, the method comprising:
selecting a plurality of sections in the document based on a plurality of inputs received to select the plurality of sections;
arranging the contents associated with the plurality of selected sections in a template; and
printing the template including the contents associated with the plurality of selected selections in a single printing job.

2. The method of claim 1, wherein the step of arranging the contents comprises setting the contents associated with the plurality of sections in a plurality of predefined divisions of the template based on predefined criteria.

3. The method of claim 2 further comprising:
logically associating the contents of the plurality of selected sections with the plurality of predefined divisions of the template; and
modifying a predefined division corresponding to a selected template when the contents associated with the selected section changes.

4. The method of claim 1 further comprising saving the template including the contents associated with the plurality of selected sections in a memory.

5. The method of claim 1, wherein the step of printing comprising printing the contents associated with the plurality of selected sections in a predefined number of pages.

6. The method of claim 1 further comprising previewing the plurality of selected sections of the document prior to printing the plurality of selected sections.

7. The method of claim 1 further comprising modifying size of the contents of one or more selected sections while printing based on a modification input, wherein modifying the size of the contents includes at least one of increasing and decreasing the size of the contents associated with the one or more selected sections while printing.

8. A computer system for printing selective contents of a document, the computer system comprising one or more processors including program instructions to:
select a plurality of sections in the document based on a plurality of inputs received to select the plurality of sections;
arrange the contents associated with the plurality of selected sections in a template; and
print the template including the contents associated with the plurality of selected selections in a single printing job.

9. The computer system of claim 8 wherein the one or more processors include further instructions to set the contents associated with the plurality of selected sections in a plurality of predefined divisions of the template based on a predefined criteria.

10. The computer system of claim 9, wherein the one or more processors include further instructions to:
logically associate the contents of the plurality of selected sections with the plurality of divisions of the template; and
modify a predefined division corresponding to a selected section when contents associated with the selected section changes.

11. The computer system of claim 8, wherein the one or more processors include further instructions to save the template including the contents associated with the plurality of selected selections in a memory.

12. The computer system of claim 8, wherein the one or more processor include further instructions to print the contents associated with the plurality of selected sections in a predefined number of pages.

13. The computer system of claim 8, wherein the one or more processors include further instructions to preview the plurality of selected sections of the document prior to printing the plurality of selected sections.

14. The computer system of claim 8, wherein the one or more processors include further instructions to modify size of the contents of one or more selected sections while printing based on a modification input, wherein modifying the size of the contents includes at least one of increasing and decreasing the size of the contents associated with the one or more selected sections while printing.

15. A computer program product for printing selective contents of a document comprising:
one or more computer-readable tangible storage devices and program instructions stored on at least one or more storage devices, the program instructions comprising:
program instructions to select a plurality of sections in the document based on a plurality of inputs received to select the plurality of sections;
program instructions to arrange the contents associated with the plurality of selected sections in a template; and
program instructions to print the template including the contents associated with the plurality of selected selections in a single printing job.

16. The computer program product of claim 15, wherein the program instruction to arrange the contents comprises a computer readable program instructions to set the contents associated with the plurality of sections in a plurality of predefined divisions of the template based on a predefined criteria.

17. The computer program product of claim 16 further comprising program instructions to:
logically associate the contents of the plurality of selected sections with the plurality of divisions of the template; and
modify a predefined division corresponding to a selected template when the contents associated with the selected section changes.

18. The computer program product of claim 15 further comprising program instructions to save the template including the contents associated with the plurality of selected sections in a memory.

19. The computer program product of claim 15, wherein the program instruction to print the template comprising program instructions to print the contents associated with the plurality of selected sections in a predefined number of pages.

20. The computer program product of claim 15 further comprising program instructions to:
preview the plurality of selected sections of the document prior to printing the plurality of selected sections; and
modify size of the contents of one or more selected sections while printing based on a modification input, wherein modifying the size of the contents includes at least one of increasing and decreasing the size of the contents associated with the one or more selected sections while printing.
